(19) United States
(12) Patent Application Publication
(10) Pub. No.: US 2004/0165382 A1
(43) Pub. Date: Aug. 26, 2004

(54) Collapsable adjustable decorative lighted window frame

(76) Inventors: Kathleen Eldridge, Grand Island, NY (US); Timothy Brown, Grand Island, NY (US)

Correspondence Address: Kathleen Eldridge, 2361 Fix Rd., Grand Island, NY, 14072, US

(21) Appl. No.: 10/373,303

(22) Filed: Feb. 26, 2003

(51) Int. Cl. F21V 21/26

(52) U.S. Cl. 362/250; 362/388

(57) ABSTRACT

A unique seasonal light decoration framing kit which is simple to construct and can be utilized season after season. The frame is easily assembled by an individual using hand tools. The unit is fully adjustable to fit most windows and collapsable for easy storage. The unit contains mountable hardware (in the form of hooks and eyes) which allows the unit to attach to any size window frame in a home or a commercial building. Industry standard strands of mini-lights are inserted into pre-fabricated holes of the frame which are equally spaced. The unit provides a unique alternative to taping or stapling decorative mini-lights in a square or rectangular window.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The field of endeavor to which this invention pertains is home decoration/decor. The invention provides a neat, simple, and economical alternative to taping or stapling seasonal decorative “mini-lights” in a square or rectangular display in home windows. The invention solves the problem of getting a uniform, neat, and durable window presentation. Years of prior experience and frustration led to the development of this product.

The product provides a collapsable, adjustable, decorative window frame that can be adjusted to fit any size window and will collapse or fold down into a unit small enough to be easily stored. The product design allows it to easily accept many mini-light strands common to this market today.

There is a desire for a lighted window decoration with a new design element which can be used during every holiday season. This invention provides the user with just such an article. The collapsable window frame would accept a strand of mini-lights which are attached to the frame through the holes which are spaced equidistant all around the frame. Once the strand of mini-lights has been attached to the window frame, the individual lights can be changed depending on the holiday season. For example, the color of the lights can be changed in the frame for each specific holiday. Red lights can be utilized for Valentine's Day; green lights can be used for St. Patrick's Day; multi-colored pastel lights can be used for Easter; red, white, and blue lights can be used for the Fourth of July; orange lights can be used for Halloween, and multi-colored lights can be used for Christmas.

### BRIEF SUMMARY OF THE INVENTION

The invention provides the user with a fully adjustable and collapsable frame kit, which, when coupled with a strand of industry standard mini-lights, would allow use throughout the various holiday seasons year after year. The color of the lights can be changed for each holiday season by simply changing the individual bulbs. The unit can be sized for each user's window. This is accomplished by having the user measure the window and determine the final width and height which will best fit their window. The user will then cut the main sections to length at pre-etched segment guide-line marks. The user easily assembles the four pieces that make up the unit. The four main frame sections are easily assembled with a simple nut/bolt combination at each of the four corners. In it's assembled form, the free-hanging unit will maintain it's square or rectangular shape due to the forces of gravity in combination with the manner it is attached to the home's window frame. When the seasonal need is over, the unit easily lifts off it's mounting points in the window frame and collapses into a single linear unit which could be stored year after year in a specialized packaging carton or tube.

### BRIEF DESCRIPTION OF THE SEVERAL VIEWS OF THE DRAWING

FIG. 1 is a front view of the four pieces that make up the unit. This is representative of the what the pieces will look like when the user pulls them from the package. The pieces have two sets of pre-fabricated spaced holes—one set of holes for the mini-lights and the other for the bolts.

FIG. 2 is a front view of the unit after it has been assembled using the nut and bolt combination. A strand of mini-lights can be inserted into the holes which are equally spaced throughout the frame.

FIG. 3 is a front view of the unit folding down into it's linear storable position.

FIG. 4 is a front view of the unit after it has been folded down to fit within the package or tube.

FIG. 5 is a front view of the unit hanging in the user's window frame. (The mini-lights are not depicted in this drawing but are placed through the holes to complete the unit.)

### INDEX TO PARTS

10—Series of pre-fabricated equally spaced holes which hold the socket of the mini-lights which will be inserted into the unit. The holes are equally spaced inside of the segmented sections which make up the frame.

20—Series of pre-fabricated holes for the bolts. These holes are in the center of each segmented section of the four individual pieces which make up the frame.

30—Pre-fabricated segmented sections of the four individual pieces which make up the frame.

40—Bolt (with nyloc nut on the back side of the frame). The nut holds the bolt into place.

50—Window frame that the unit attaches to.

60—Hook that attaches to the window frame.

70—Eye hook that attaches to the top piece of the unit.

### DETAILED DESCRIPTION OF THE INVENTION

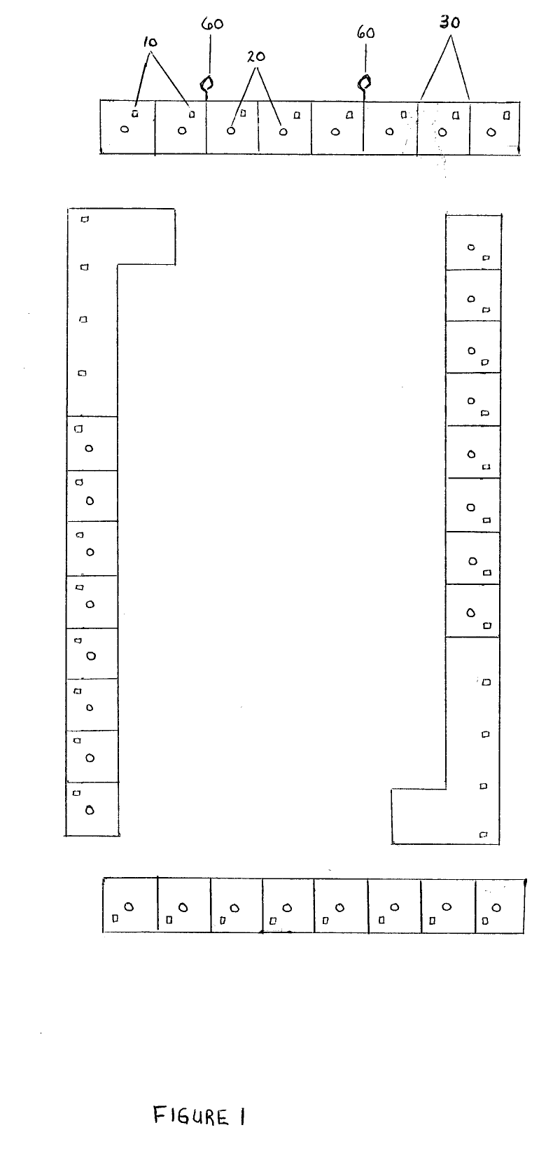

The unit is constructed from four pieces of wood or plastic, with a thickness of one quarter inch to one-half inch (as depicted in FIG. 1). The two side pieces are five feet long and have a straight edge with an adjacent piece forming an L shape. The adjacent piece is one inch long. The top and bottom pieces are four feet long and are straight. The width of all the pieces is one inch. Each of the four pieces contains two inch “segments” which are fully adjustable because they can be cut and sized according to the user's needs. The user simply measures the window and determines what size unit they need. Then, the user cuts the unit to size using the pre-etched segment guideline marks. Each segmented piece contains properly located holes which serve as the corner attachment and pivot points of the frame. After the user makes the appropriate measurements, and cuts the four pieces of the frame accordingly, the unit can then be easily assembled with simple hand tools.

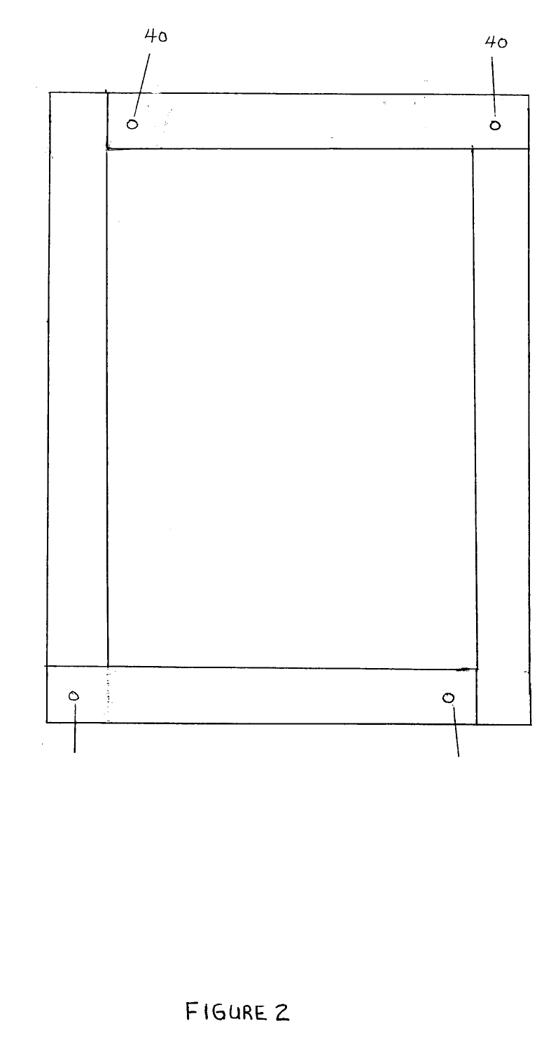

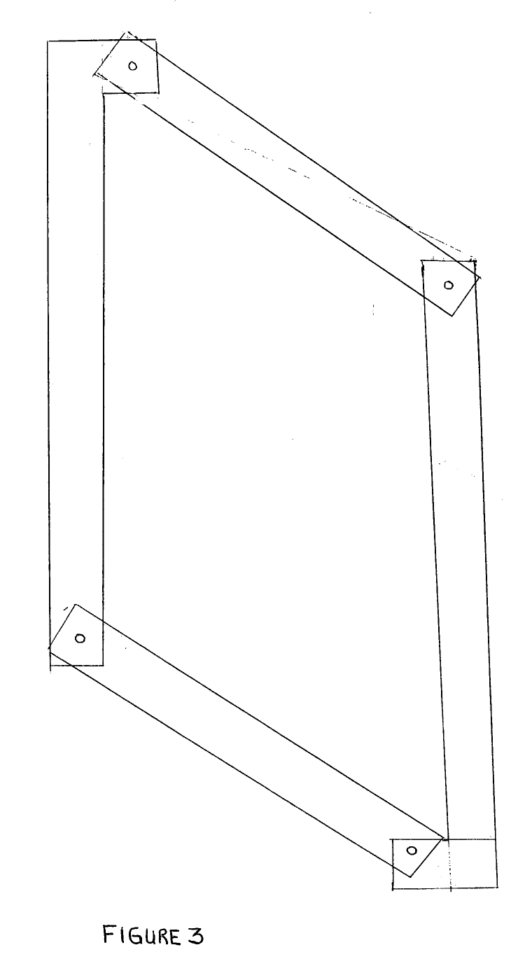

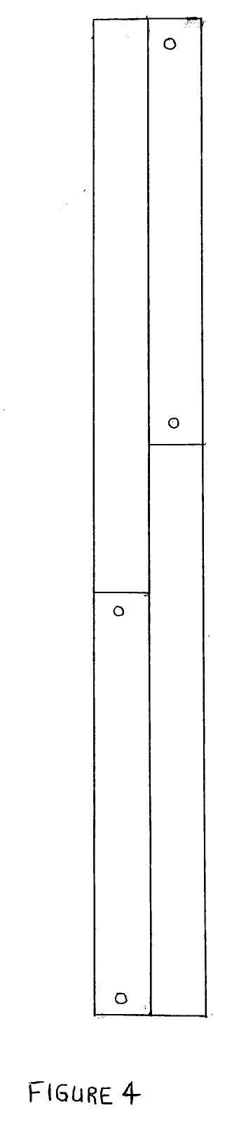

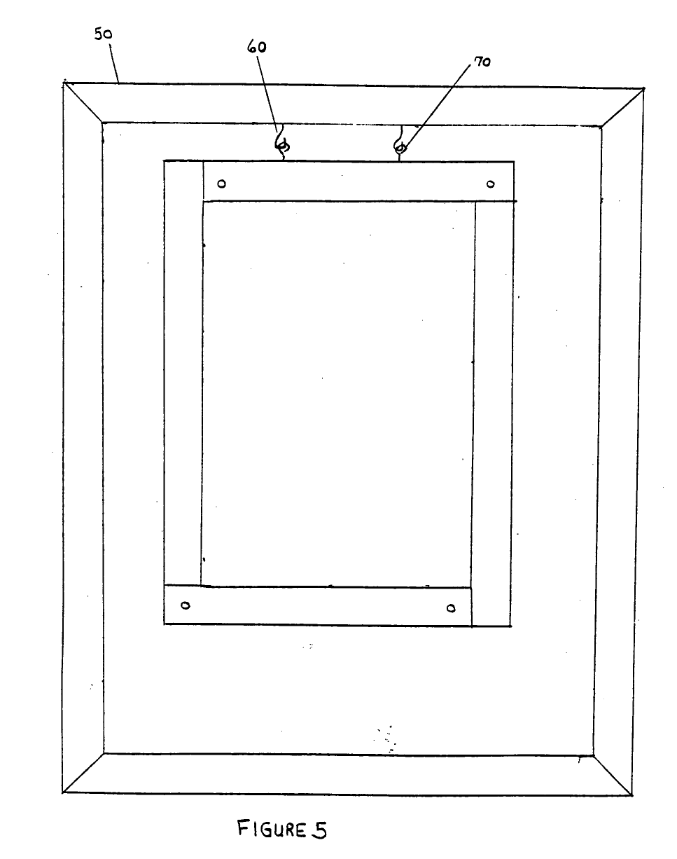

The pieces assemble together using a simple bolt and nyloc nut combination forming a frame (as depicted in FIG. 2). Once the frame is assembled, the user will insert a user-supplied strand of mini-lights through the pre-fabricated holes. The holes are pre-fabricated to fit a standard miniature bulb socket. The socket will fit tightly through the holes and the holes are spaced equidistant throughout the frame. The lights are inserted in each hole (or every other hole at the user's discretion) around the frame starting with the lower left hand corner. The frame will then be attached to the inside of the user's window frame in their house or commercial building via a hook and eye (as depicted in FIG. 5). Two eyes will be attached to the upper edge of the unit and two hooks will be attached to the inside window frame of the user's home or commercial structure. The unit can be taken down and folded into a linear structure for easy storage (as depicted in FIGS. 3 and 4).

The user of the unit can change the bulbs in the mini-light strand for each holiday throughout the year. For example, red bulbs for Valentine's Day; green lights for St. Patrick's Day; multi-colored pastel bulbs for Easter; red, white and blue bulbs for Fourth of July; orange bulbs for Halloween; and multi-colored lights for Christmas.

1. We claim that the unit can be collapsed or folded down to a reasonable size based on the design elements of the frame, so that the unit can be easily stored in a special container or tube.

2. We claim a decorative lighted window frame kit which is fully adjustable because it can be easily sized according to the user's need. The unit can be sized down by cutting off pre-fabricated segments from the four pieces of the frame.

3. We claim that due to the manner in which the frame kit mounts to the home's window frame, put-up and take-down time should be less than one minute—the sole exception being the first time it is installed.

4. We claim that the assembled unit can be hung inside most residential (and many commercial) window frames such that uniform display of readily available industry standard mini-lights can be achieved.

5. We also claim that the unit will allow for the color of the bulbs to be changed based on the holiday or season.
